(19) United States
(12) Patent Application Publication
(10) Pub. No.: US 2026/0039538 A1
(43) Pub. Date: Feb. 5, 2026

(54) AUTOMATED GENERATION OF INFORMATION TECHNOLOGY (IT) ALERT PROCESSING RULES

(71) Applicant: ServiceNow, Inc., Santa Clara, CA (US)

(72) Inventors: Darius Koohmarey, San Diego, CA (US); Ashwin Patti, Fremont, CA (US); Kavini Mehta, Fremont, CA (US)

(21) Appl. No.: 18/789,503

(22) Filed: Jul. 30, 2024

(51) Int. Cl. H04L 41/0631; H04L 41/069; H04L 41/16

(52) U.S. Cl. CPC H04L 41/0631; H04L 41/069; H04L 41/16

(57) ABSTRACT

In the present application, improved techniques for automatically generating alert processing rules are disclosed. One aspect of the disclosure includes a method for automatically generating alert processing rules. In some embodiments, the method includes receiving information technology (IT) alert data comprising a plurality of IT alerts. Context information relevant to IT alert processing is identified from a subset of the IT alert data. One or more patterns indicative of IT alert processing in response to the subset of the IT alert data are extracted from the subset of the IT alert data. An IT alert processing rule is determined based on the one or more patterns and the context information. The IT alert processing rule is enabled in a production environment.

### BACKGROUND OF THE DISCLOSURE

Information technology (IT) operations (ITOps) describe the people, processes, and services associated with delivering quality IT services and keeping digital services up and running. Artificial intelligence (AI) for operations (AIOps) represents the merging of AI and ITOps, referring to multi-layer tech platforms that apply machine learning, analytics, and data science to automatically identify and resolve IT operational issues.

### BRIEF DESCRIPTION OF THE DRA WINGS

Various embodiments of the disclosure are disclosed in the following detailed description and the accompanying drawings.

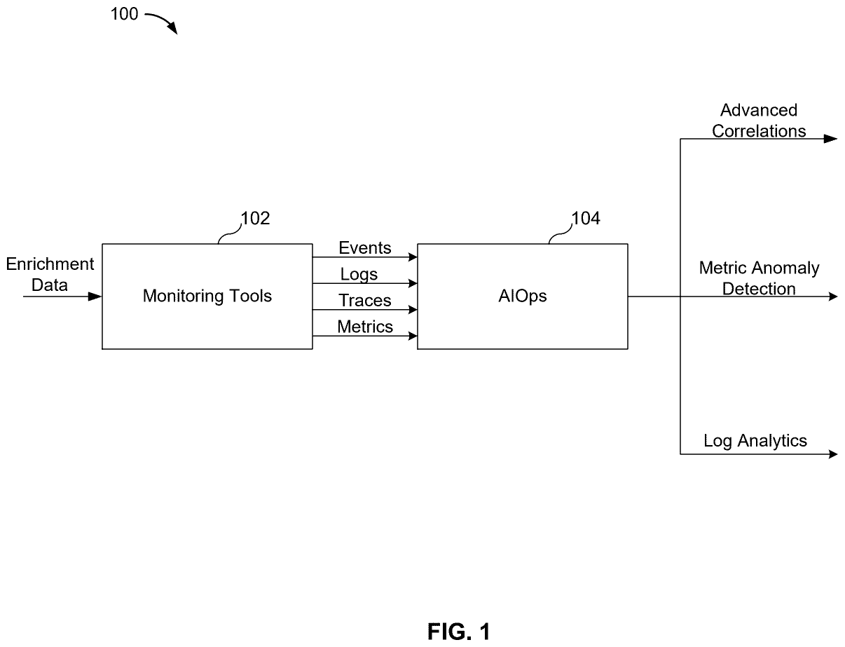

FIG. 1 illustrates an example of an AIOps system.

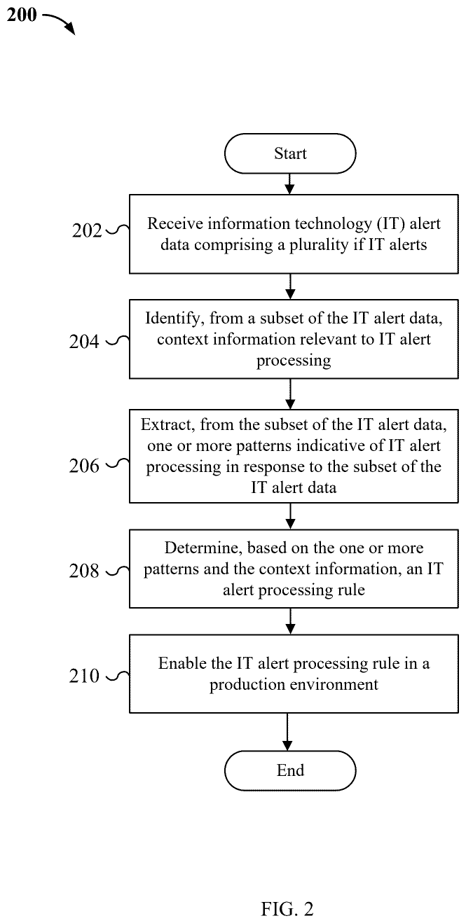

FIG. 2 illustrates an example of a process for automatic creation of alert rules for grouping information, escalation/remediation, and alert enrichment.

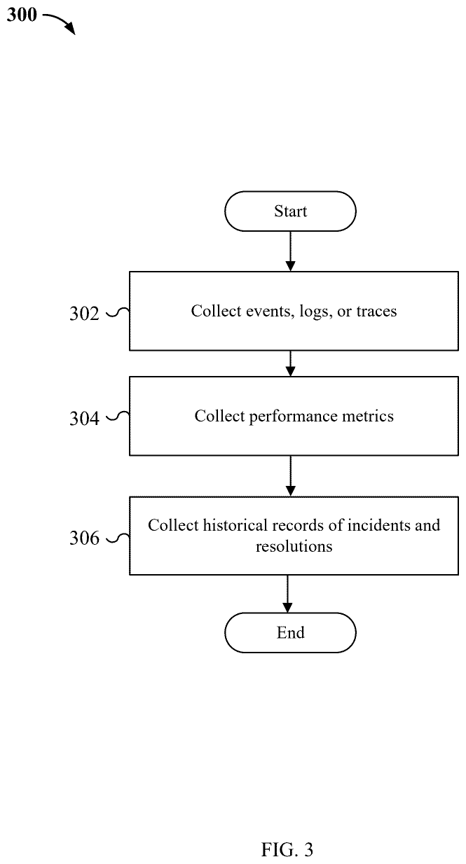

FIG. 3 illustrates an example of a process for receiving different types of IT alert data.

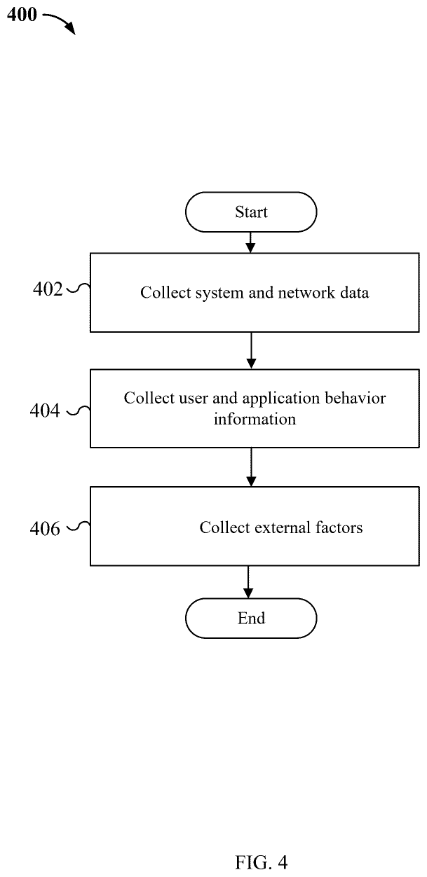

FIG. 4 illustrates an example of a process for discovering different types of context information relevant to IT alert processing, such as any relevant information regarding the environment and its users.

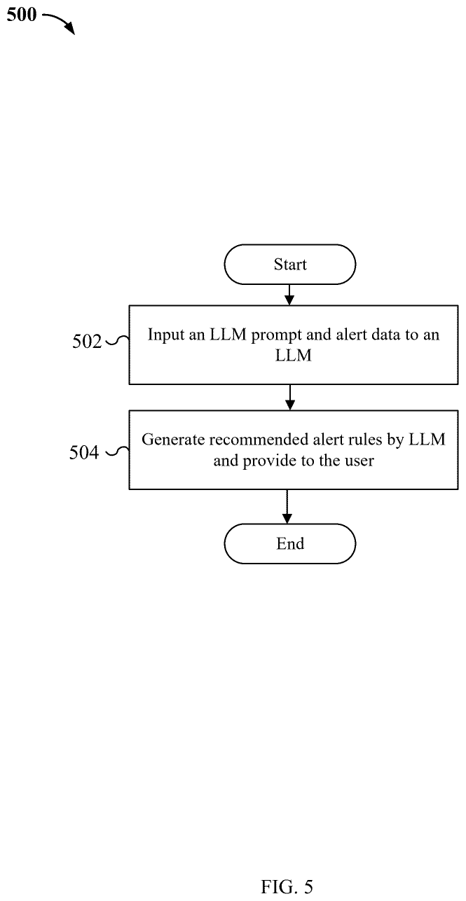

FIG. 5 illustrates an example of a process for extracting one or more patterns indicative of IT alert processing in response to the subset of the IT alert data and determining an IT alert processing rule based on the one or more patterns and the context information.

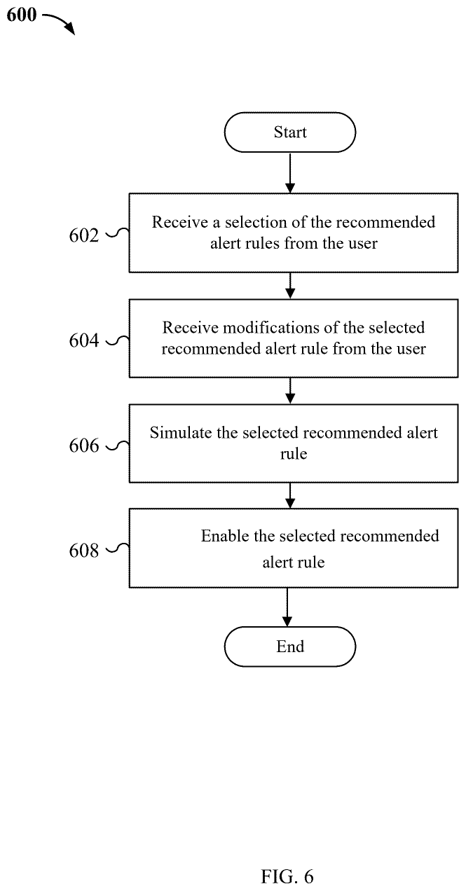

FIG. 6 illustrates an example of a process for enabling an IT alert processing rule in a production environment.

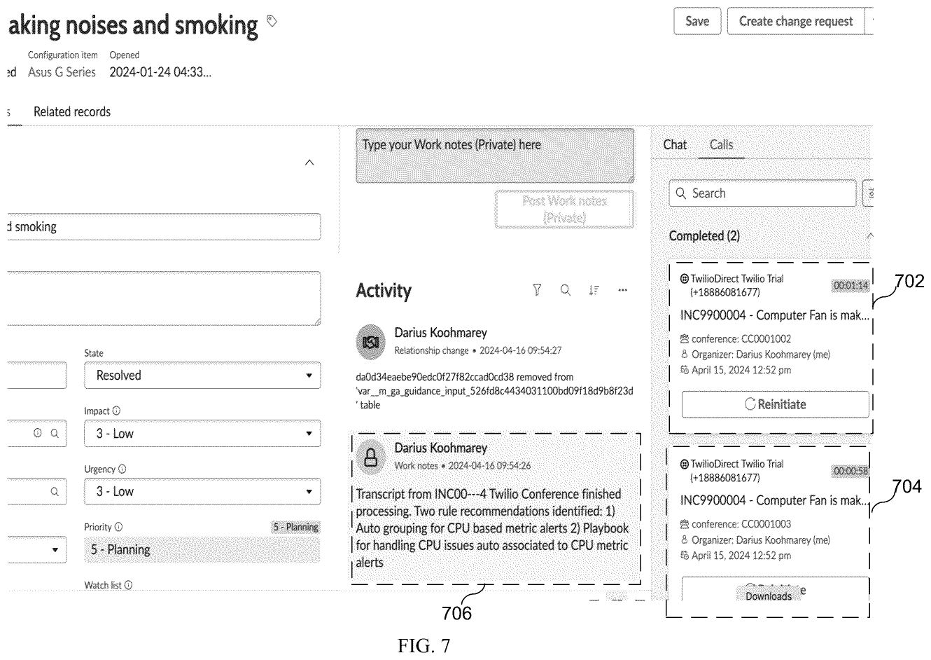

FIG. 7 illustrates one example of context data being collected as inputs to an LLM for generating alert rules.

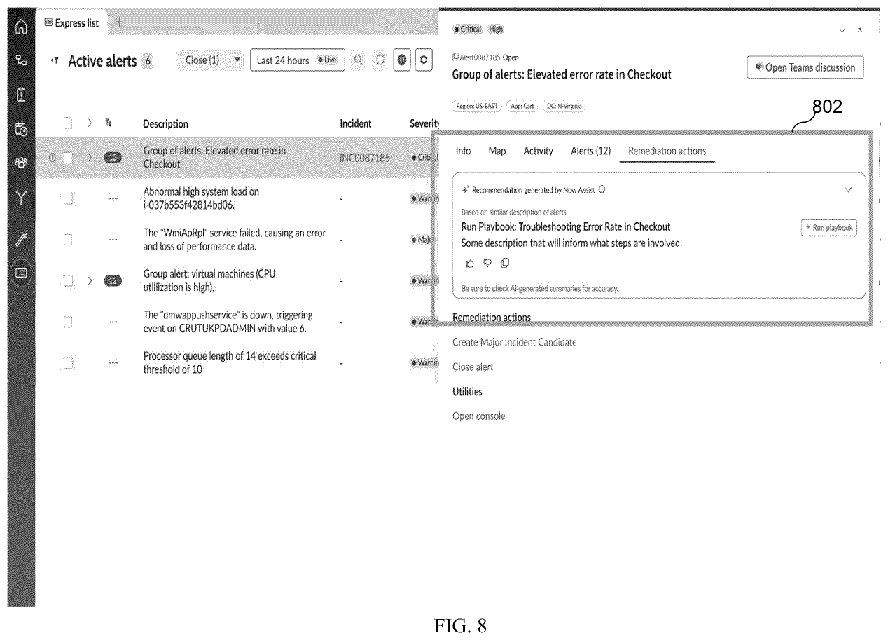

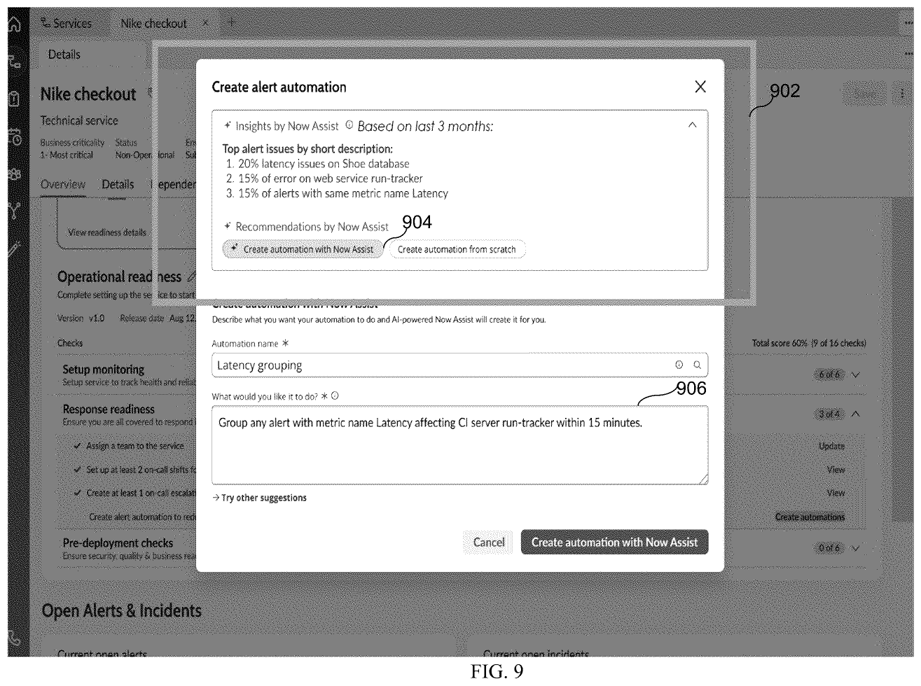

FIG. 8 illustrates examples of auto-remediation rules generated by the AIOps module to handle different types of active alerts.

FIG. 9 illustrates an example of creating alert grouping automations.

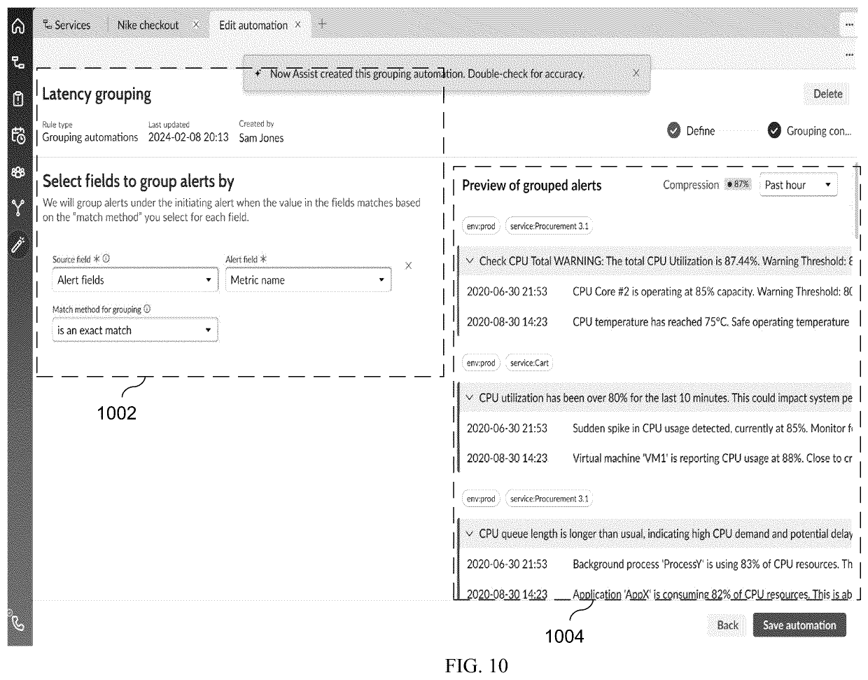

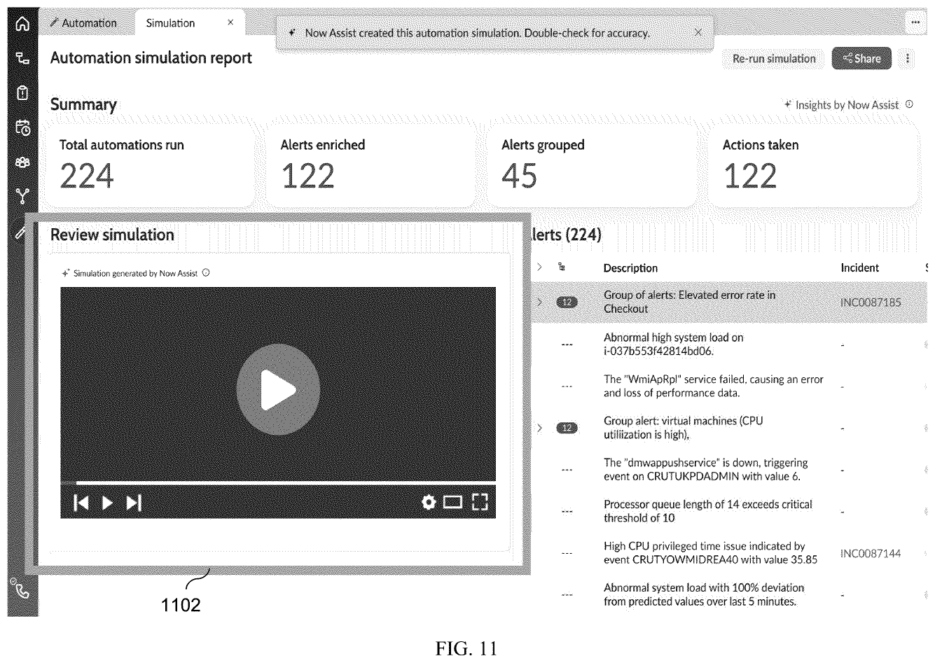

FIG. 10 illustrates an example of the grouping automation rule that is created by the AIOps module.

FIG. 11 illustrates an example of an automation simulation report.

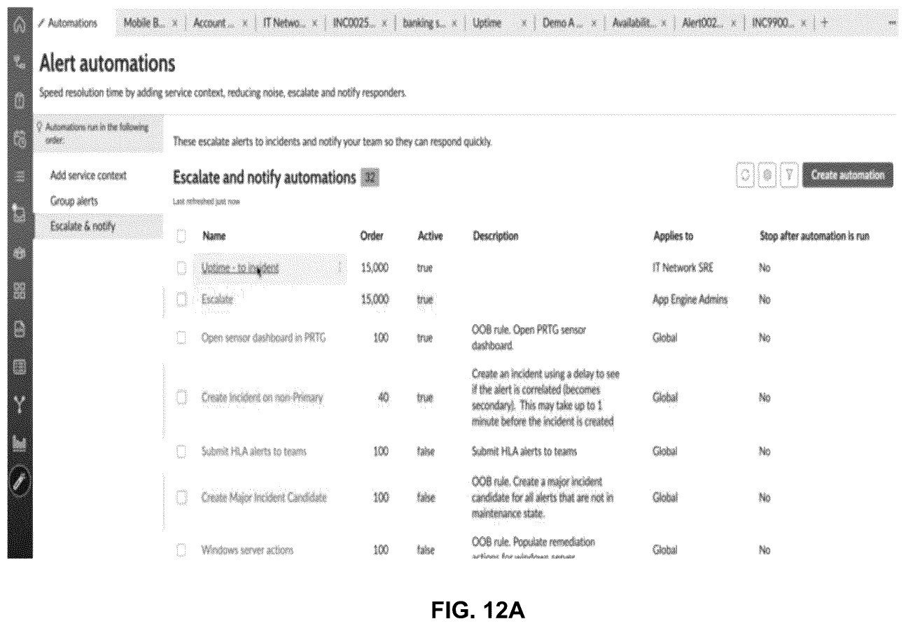

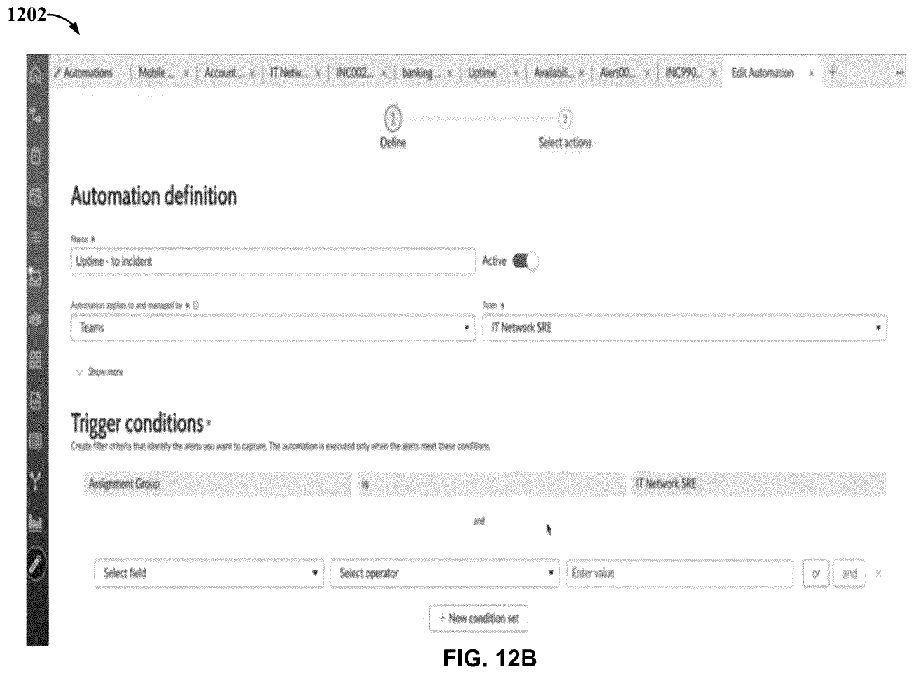

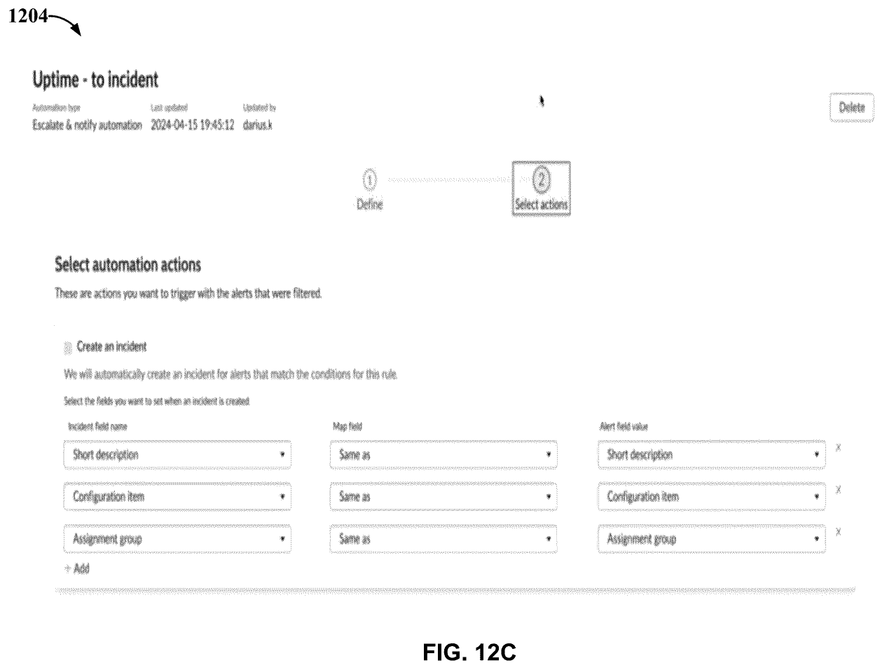

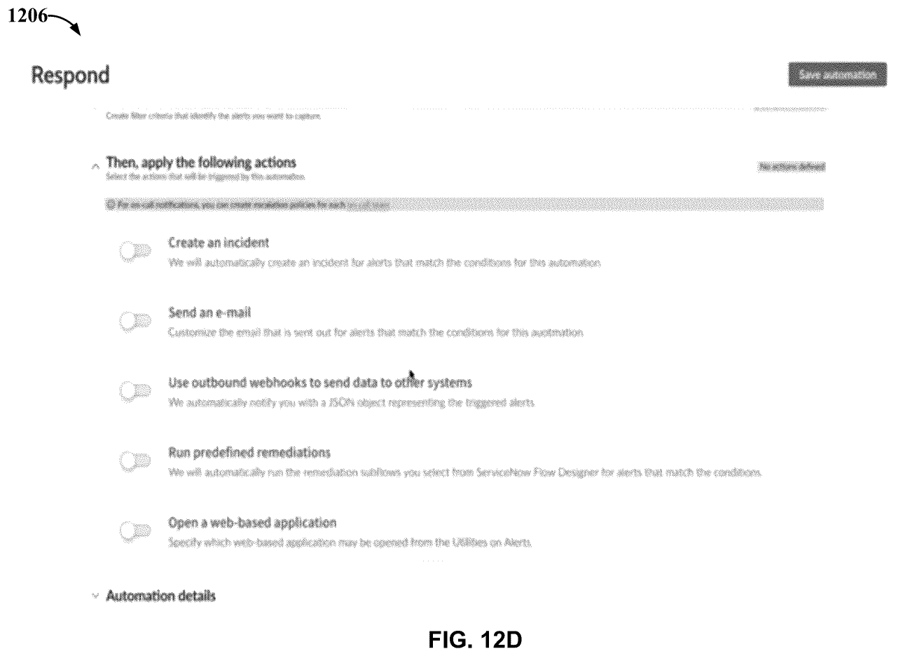

FIG. 12A shows a list of rules for escalating alerts to incidents and notifying the IT team.

FIG. 12B shows a GUI for defining a rule.

FIG. 12C shows a GUI for defining the actions associated with a rule.

FIG. 12D shows a GUI for selecting different actions associated with a rule.

### DETAILED DESCRIPTION

Various implementation disclosed herein include a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the disclosure may take, may be referred to as techniques. In general, the order of the steps of disclosed processes may be altered within the scope of the disclosure. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the disclosure is provided below along with accompanying figures that illustrate the principles of the embodiments. The disclosure is described in connection with such embodiments, but the disclosure is not limited to any embodiment. The scope of the embodiments is limited only by the claims and the disclosure encompasses numerous alternatives, modifications and equivalents. Numerous specific details are set forth in the following description in order to provide a thorough understanding of the disclosure. These details are provided for the purpose of example and the disclosure may be practiced according to the claims without some or all of these specific details. For the purpose of clarity, technical material that is known in the technical fields related to the disclosure has not been described in detail so that the disclosure is not unnecessarily obscured.

FIG. 1 illustrates an example of an AIOps system 100. Enrichment data may be associated with the cloud, applications, databases, containers, servers, storage, and the like. Monitoring tools 102 may output different types of information, including logs, traces, metrics, and events, which are then received by an AIOps module 104.

Monitoring tools 102 may serve different aspects of IT infrastructure and application monitoring, from cloud-specific monitoring to comprehensive application performance management and log analysis. For example, monitoring tools 102 may include agent software for monitoring a company's infrastructure and installed applications, with monitoring capabilities for servers, databases, application servers, and middleware. Some monitoring tools 102 may include network monitoring tools that enable discovery and monitoring across network devices, including firewalls, switches, and load balancers. Some monitoring tools 102 may collect data from diverse sources, such as servers, containers, databases, and third-party services. Some monitoring tools 102 may monitor, search, and analyze machine-generated big data from various sources.

Monitoring tools 102 may output various types of data, including events, logs, traces, and metrics, that may indicate the performance, health, and behavior of the monitored systems. These various types of data are hereinafter also referred to as alert data. Each type of output provides a different layer of insight, and together, they offer a comprehensive view of the system's health and performance.

However, events, logs, traces, and metrics can accumulate rapidly, especially in large-scale systems or environments with high-frequency data collection. One of the key challenges is scalability. Scaling anomaly detection, logging of analytics, and computing correlation in real-time or near-real-time pose scalability challenges in terms of processing efficiency, memory requirements, and computational overhead. A company (e.g., a telecom service provider) may face a significant challenge when millions of events, logs, traces, and metrics need to be processed simultaneously. Streaming millions of data points may create an overload, even before the processing of the data begins. Therefore, improved techniques are needed to handle the volume and velocity of the data and ensure timely detection and resolution of IT operational issues.

In the present application, rules are automatically created for filtering, compressing, and grouping the various types of data received from monitoring tools 102. For example, alerts triggered by the events received from monitoring tools 102 are filtered, compressed, or grouped, such that a large number of alerts are reduced down to a small number of actionable alerts. Rules are automatically created to respond to certain events and classify them as major incidents or critical issues. Rules are automatically created to manage on-call escalation policies or trigger self-healing and proactive actions, such as rebooting a server or adding a playbook of steps to an alert. For instance, an alert response may include steps, such as rebooting the server and running an upgrade script. The improved techniques automate the creation of these alert rules for grouping information, escalation/remediation, and alert enrichment.

In some embodiments, alert data may be inputted into a machine learning (ML) model (e.g., a large language model (LLM)). Trends, groupings, categories, and rules may be identified by the ML model and recommended to the system administrators. Based on the recommendations, the system administrators may create or adopt the rules for handling events and alerts. A system administrator may enter a natural language input for creating one or more rules based on the outputs of the ML model. For example, the system administrator may enter a natural language input request, such as “group together any alerts that indicate latency.” In some embodiments, a simulation feature may be provided to the user to allow the user to see the potential impact of the rule before activating it. This comprehensive workflow helps the user to understand the necessary alert automation, define it using natural language and a user interface, and predict its impact before activation. One advantage is that it eliminates the need for a manual process by the system administrator to build the rules from scratch using a user interface.

In some embodiments, AIOps module 104 achieves a 90% noise reduction by compressing information, allowing IT teams to focus on the actual and critical issues. The module automatically highlights the root cause of problems and performs impact analysis, streamlining the troubleshooting process and minimizing downtime. Additionally, it provides event management correlation, linking related events to provide a clearer picture of issues and reducing the complexity of managing large volumes of data. Finally, AIOps module 104 generates actionable alerts and incidents, ensuring that IT teams receive timely and relevant notifications to promptly address and resolve issues.

AIOps module 104 may provide advanced correlation, metric anomaly detection, and log analytics. For example, advanced correlation clusters the events and detects patterns in the events. Metric anomaly detection triggers actions and reduces outages. Log analytics predict issues based on anomaly patterns. In addition, the AI model can also recommend actions for automatic alert record enrichment (e.g., severity, description, and tags) as well as escalation into incidents for major incident swarming.

AIOps module 104 predicts problems before they occur without relying on configured rules or thresholds. Language-based anomalies are detected. Both of these can help automate troubleshooting and reduce time to diagnose the issue by identifying the right configuration item (CI). Sensitive escalation is triggered via on-call or other notification channels. AIOps module 104 responds by implementing on-call and escalation policies, and managing major incidents. AIOps module 104 improves visibility into service health at the service-level objective (SLO) level and manages error budgets. A service level objective (SLO) is an agreed-upon performance target for a particular service over a period of time. AIOps module 104 automates workflow-driven remediation, enriches and groups alerts, proactively allocates resources, and enables self-healing.

In the present application, improved techniques for automatically generating alert processing rules are disclosed. One aspect of the disclosure includes a method for automatically generating alert processing rules. In some embodiments, the method includes receiving information technology (IT) alert data comprising a plurality of IT alerts. Context information relevant to IT alert processing is identified from a subset of the IT alert data. One or more patterns indicative of IT alert processing in response to the subset of the IT alert data are extracted from the subset of the IT alert data. An IT alert processing rule is determined based on the one or more patterns and the context information. The IT alert processing rule is enabled in a production environment.

Additional implementations of the disclosure may include one or more of the following optional features. A query is generated based on the one or more patterns and the context information. The query is processed using a machine learning (ML) model to determine the IT alert processing rule. The query is generated by generating a large language model (LLM) prompt for an LLM to determine the IT alert processing rule, wherein the LLM prompt instructs the LLM to determine the IT alert processing rule based at least in part on the one or more patterns and the context information. The LLM prompt for the LLM to determine the IT alert processing rule for grouping at least some IT alerts into an IT alert group is generated, wherein the LLM prompt instructs the LLM to determine the IT alert processing rule based at least in part on one or more patterns of grouping at least some of the plurality of IT alerts into the IT alert group. The LLM prompt for the LLM to determine the IT alert processing rule for remediating at least some IT alerts is generated, wherein the LLM prompt instructs the LLM to determine the IT alert processing rule based at least in part on one or more patterns of remediating at least some of the plurality of IT alerts. Remediating the at least some IT alerts comprises assigning criticality levels to the at least some IT alerts. Remediating the at least some IT alerts comprises assigning a playbook comprising a plurality of steps or approvals across an organization. The LLM prompt for the LLM to determine the IT alert processing rule for enrichment of at least some IT alerts is generated, wherein the LLM prompt instructs the LLM to determine the IT alert processing rule based at least in part on one or more patterns of enrichment of at least some of the plurality of IT alerts. Enrichment of the at least some IT alerts comprises assigning one of the at least some IT alerts to a responsible department. The context information is identified based on a technical support transcript related to an IT alert. The context information is identified based on system or network data. Receiving the IT alert data comprises receiving IT events, IT logs, IT traces, or IT performance metrics. The IT alert processing rule is provided to a user via a graphical user interface (GUI). One or more modifications to the IT alert processing rule are received from the GUI. The IT alert processing rule with the one or more modifications is enabled. The IT alert processing rule is simulated using at least some of the IT alert data. An approval of the IT alert processing rule is received via a GUI. The IT alert processing rule is enabled in response to the approval.

Another aspect of the disclosure provides a system with one or more processors and a memory coupled to the one or more processors. The memory is configured to provide the one or more processors with instructions. When executed, the instructions cause the one or more processors to receive information technology (IT) alert data comprising a plurality of IT alerts; identify, from a subset of the IT alert data, context information relevant to IT alert processing; extract, from the subset of the IT alert data, one or more patterns indicative of IT alert processing in response to the subset of the IT alert data; determine, based on the one or more patterns and the context information, an IT alert processing rule; and enable, in a production environment, the IT alert processing rule.

Another aspect of the disclosure provides a computer program product embodied in a non-transitory computer readable medium and comprising computer instructions for receiving information technology (IT) alert data comprising a plurality of IT alerts; identifying, from a subset of the IT alert data, context information relevant to IT alert processing; extracting, from the subset of the IT alert data, one or more patterns indicative of IT alert processing in response to the subset of the IT alert data; determining, based on the one or more patterns and the context information, an IT alert processing rule; and enabling, in a production environment, the IT alert processing rule.

Implementations disclosed herein provide many benefits over known techniques. For example, automatically creating alert rules using an LLM allows alert rules to be discovered with minimal waste of time, resources, or effort. Further, the implementations of the current disclosure eliminate the need for a system administrator to monitor large amounts of alert data to identify repeated issues. They also minimize the need to manually configure alert rules or perform remediation steps for critical issues. The system administrator may use a graphical user interface (GUI) to fine tune a recommended alert rule, simulate it on past data, and then enable the alert rule in production to handle IT issues.

FIG. 2 illustrates an example of a process 200 for automatic creation of alert rules for grouping information, escalation/remediation, and alert enrichment. In some embodiments, process 200 is performed by AIOps module 104 in FIG. 1.

At 202, information technology (IT) alert data is received. The IT alert data includes a plurality of IT alerts. Monitoring tools 102 may output different types of information, including logs, traces, metrics, and events, which are then received by AIOps module 104.

Monitoring tools 102 may output various types of data, including events, logs, traces, and metrics, that may indicate the performance, health, and behavior of the monitored systems. These various types of data are hereinafter also referred to as alert data. Each type of output provides a different layer of insight, and together, they offer a comprehensive view of the system's health and performance.

FIG. 3 illustrates an example of a process 300 for receiving different types of IT alert data. In some embodiments, process 300 may be performed at step 202 of process 200. Process 300 collects different types of IT alert data. However, the types of IT alert data disclosed in process 300 are illustrative examples only, and therefore are non-limiting. In addition, the types of IT alert data collected are different for different types of automatically generated recommended rules, including alert rules for grouping information, escalation/notification/remediation, and alert enrichment. Therefore, collection of some types of IT alert data may be optional. The collection of the different types of IT alert data helps in identifying trends and patterns. The IT alert data is useful for predicting potential future issues and enabling proactive measures to prevent them.

At 302, events, logs, or traces are collected. Events are significant occurrences or changes in state within a system that are important for monitoring and alerting purposes. Examples include server restarts, configuration changes, user logins, and threshold breaches (e.g., high central processing unit (CPU) usage). Logs are detailed records of events that occur within a system, network, or an application. They provide a sequential, time-stamped account of actions and states. Examples include error messages, user actions, system warnings, and application transactions. Traces may follow the path of a request as it moves through different services and components of a distributed system. They may provide end-to-end visibility of a transaction. For example, a trace may show the flow of a user's request from the web front-end to the database, including the time taken at each step.

At 304, performance metrics are collected. Metrics are numerical data points that measure the performance and health of various components of the system over time. They are typically collected at regular intervals. Examples include CPU usage, memory consumption, network throughput, application response times, request rates, and error rates.

At 306, historical records of alerts or incidents and their resolutions are collected. This includes the steps that have been taken or rules that have been applied to resolve certain past issues. In one example, a critical incident involves memory leak issues, and the resolutions involve multiple steps. When a monitoring system detects memory usage exceeding a certain threshold for over a certain time period, indicating a potential memory leak, it triggers an automated script. The script first attempts to terminate problematic processes and free up memory by clearing cache and temporary files. When memory usage remains critical, the system alerts an IT administrator, who then decides to initiate a safe server reboot. After the reboot, the IT administrator checks to ensure memory usage is back to normal and logs all actions taken. This combination of automated response and human intervention ensures prompt handling of critical memory issues, maintaining system stability with minimal downtime.

Referring back to FIG. 2, at 204, context information relevant to IT alert processing is identified from a subset of the IT alert data. FIG. 4 illustrates an example of a process 400 for discovering different types of context information relevant to IT alert processing, such as any relevant information regarding the environment and its users. In some embodiments, process 400 may be performed at step 204 of process 200. Context information refers to the comprehensive set of data and metadata that provides insights and background necessary for effective analysis, decision-making, and automation in IT operations. This context helps in understanding the current state, historical trends, and potential future scenarios of IT environments. Context information may include historical data or past data. For example, historical data may be collected over a longer time frame and is used for more comprehensive analysis. Past data may be more recent and may be more relevant for immediate decision-making and shorter-term analysis. For example, past data may include more recent information about the existing functionality on the platform. Process 400 collects different types of context data. However, the types of context data disclosed in process 400 are illustrative examples only, and therefore are non-limiting. In addition, the types of context data collected are different for different types of automatically generated recommended rules, including alert rules for grouping information, escalation/notification/remediation, and alert enrichment. Therefore, collection of some types of context data may be optional.

At 402, system and network data are collected. This includes information about the architecture, configuration, and status of hardware, software, and network components. This type of context information may include topology and dependencies information, which includes information about the relationships and dependencies between different components within the IT environment.

At 404, user and application behavior information is collected. Patterns of usage and interaction with applications, including user sessions, browsing history, transaction volumes, technical support sessions, and access patterns are collected.

At 406, external factors are collected. This type of context information includes data on external influences, such as security threats, regulatory requirements, and changes in the external environment that could impact IT operations.

Referring back to FIG. 2, at 206, one or more patterns indicative of IT alert processing in response to the subset of the IT alert data are extracted from the subset of the IT alert data. At 208, an IT alert processing rule is determined based on the one or more patterns and the context information.

The process of creating automated IT alert processing rules includes the comprehensive analysis of current and historical data, including events, logs, metrics, traces, and alerts. This data is combined with current or past context information, including system architecture, environment configurations, network topology, user and application behavior information, external factors, and the like. Different techniques, such as machine learning (ML), may be used to identify patterns and trends within this data. For example, recurrent memory leaks, disk space issues, or specific error patterns may be detected through analysis. Additionally, patterns of previous remediation steps taken in response to similar alerts or incidents may be identified. This analysis helps in predicting potential future issues and formulating automated responses. The resulting rules and models enable the system to autonomously process alerts, initiate pre-defined remediation actions, and dynamically adjust system operations, thereby enhancing operational efficiency and reducing mean time to resolution (MTTR). This proactive approach ensures that IT operations are more resilient and capable of handling anomalies with minimal human intervention.

For example, past alerts may reveal a pattern of memory usage exceeding a certain threshold for over a certain time period, typically indicating a memory leak. Historical data shows that an automated script is triggered to terminate problematic processes and clear cache and temporary files. When memory usage remains high, the system alerts an IT administrator who then reboots the server and verifies that memory usage returns to normal. By analyzing these recurring alerts and the effectiveness of the remediation steps, AIOps module 104 in AIOps system 100 can create an automated alert rule. This rule might include automatically escalating the issue to the IT administrator if initial automated steps fail, or even preemptively restarting specific services known to cause memory leaks. Over time, this refined rule can adapt to variations in the alerts, ensuring more efficient handling of memory leaks with minimal downtime and reducing the need for human intervention.

FIG. 5 illustrates an example of a process 500 for extracting one or more patterns indicative of IT alert processing in response to the subset of the IT alert data and determining an IT alert processing rule based on the one or more patterns and the context information. In some embodiments, process 500 may be performed at step 206 and step 208 of process 200.

At 502, an LLM prompt and at least some of the collected alert data are sent to an LLM as inputs. The collected alert data may include historical monitoring information or current context information, including events, logs, traces, metrics, and the like. Prebuilt LLM prompts are seeded with platform alert data using a retrieval-augmented generation (RAG) approach. Custom prebuilt LLM prompts may include predefined or pre-configured prompts designed to interact with an LLM. Retrieval-augmented generation (RAG) is an AI framework for improving the quality of LLM-generated responses by grounding the model on external sources of knowledge to supplement the LLM's internal representation of information. The LLM is augmented with specific alert data retrieved from the platform, enhancing its ability to generate accurate, contextually appropriate, and relevant responses or insights based on that data.

At 504, one or more alert rules are generated by the LLM and provided to the user as recommended alert rules. In some embodiments, the generated recommended alert rules may be proactively provided to the user. In some embodiments, the generated recommended alert rules may be provided in response to a user request. For example, the system administrator may enter via a graphical user interface (GUI) a natural language request for a new alert rule. The natural language request may include the context, requirements, or other information about the requested alert rule.

Referring back to FIG. 2, at 210, the IT alert processing rule is enabled in a production environment. FIG. 6 illustrates an example of a process 600 for enabling an IT alert processing rule in a production environment. In some embodiments, process 600 may be performed at step 210 of process 200.

At 602, a selection of the recommended alert rules is received from the user. The user may select and accept at least one of the recommended alert rules via a GUI.

At 604, modifications of the selected recommended alert rule are received from the user. For example, the user may enter in natural language via the GUI what the user needs, the context, or other information. The user may also modify the selected recommended alert rule by directly editing the alert rule and its associated fields, attributes, flags, and the like.

At 606, the selected recommended alert rule is simulated. The selected recommended alert rule is applied in a simulated environment including the system and simulated alert data, such as historical alert data that was previously collected from the system. The simulated results of the selected recommended alert rule are provided and displayed to the user. The simulated results allow the user to see the potential impact of the rule before activating it. This comprehensive workflow helps the user to understand the necessary alert automation, define it using natural language and a user interface, and predict its impact before activation.

At 608, the selected recommended alert rule is enabled. The alert rule automation is activated in production. In other words, AIOps module 104 in AIOps system 100 automatically identifies and resolves certain IT operational issues according to the enabled alert rule.

FIG. 7 illustrates one example of context data being collected as inputs to an LLM for generating alert rules. In particular, information may be collected from a live technical support session between a system administrator and an end-user in order to resolve an IT issue. In this particular example, the system administrator is helping a user via a live technical support session to resolve the problem of a computer fan making noises and releasing smoke. For example, the user and the system administrator may communicate in real-time, discussing the issue in detail via a chat or phone session. The administrator may ask for additional information, request logs, or provide instructions for troubleshooting.

As shown in FIG. 7, two live technical support sessions (702 and 704) were conducted. The transcripts of the two live technical support sessions may be collected and processed by process 400 and fed as inputs into the LLM at step 502 of process 500 for generating the alert rules at step 504 of process 500. The GUI element 706 shows that two rule recommendations are identified by the LLM. The first recommended alert rule is a rule related to auto-grouping for CPU-based metric alerts. The second recommended alert rule is a rule related to creating a remediation playbook for handling CPU issues that are automatically associated with CPU metric alerts.

In this example, the generation of the recommended rules by the LLM is based on historical data as well as the live collaboration/discussion context that happened as issues were being worked on by the system administrator or his team. For example, using RAG, the LLM is augmented with these historical and context data, enhancing its ability to generate accurate, contextually appropriate, and relevant responses or insights based on patterns identified in these data. The historical data may include information collected from past live technical support sessions regarding other previous alerts or the resolutions and steps taken regarding those previous alerts. For example, for a particular past live technical support session, the collected data may include platform data, such as live data, performance metrics, logs, diagnostic results, and alerts relevant to the issue being discussed. The collected data may include the shared files/screens that were used to facilitate troubleshooting. The collected data may include the resolution or workaround for the issue, including configuration changes, scripts, or manual steps. The collected data may include any incident documentation, such as chat transcript, actions taken, and resolution steps. The collected data may include the feedback from the user.

FIG. 8 illustrates examples of auto-remediation rules generated by the AIOps module 104 to handle different types of active alerts. Auto remediation rules are predefined guidelines or actions within an IT system that automatically detect and correct issues without human intervention. These rules are designed to maintain system stability, performance, and security by addressing common problems swiftly and efficiently. For example, the GUI element 802 shows that the remediation actions generated for the group of alerts “Elevated error rate in Checkout” include running the playbook “Troubleshooting Error Rate in Checkout.” A playbook is a guided, step-by-step process designed to help users navigate complex workflows and tasks, particularly those that involve multiple steps, approvals, and interactions across different parts of the organization. Playbooks are used to standardize and streamline processes, ensuring consistency and efficiency.

FIG. 9 illustrates an example of creating alert grouping automations. As shown in GUI element 902, the top alert issues are listed, and different icons are provided for the user to create alert grouping automations.

As shown in GUI element 902, based on the last three months of the alerts that are sent to the LLM, the top alert issues are grouped into three categories. For example, 20% of the alerts are related to latency issues, 15% of the alerts are related to having errors on web services, and 15% of the alerts have the same metric name “latency.” These categories are recognized by the LLM as the trends and patterns within the alert data. A button 904 is provided to the user for automatically creating the alert automations based on the categories. The user may also request for a new alert rule created based on the categories, namely by entering a natural language prompt in a GUI text entry element 906, describing what the user wants the automation to do.

FIG. 10 illustrates an example of the grouping automation rule that is created by AIOps module 104. As shown in 1002, the rule name is “Latency grouping.” The rule type is “Grouping automations.” Different fields of the grouping rule may be selected by the user. In this example, the source field is “Alert fields,” and alerts that have the same metric name are grouped together. The user may view and modify the logic of the rule by editing the source field, alert field, and the match method for grouping. A preview of the grouped alerts using the rule is shown in 1004, which achieves an 87% compression of the alerts. The preview or simulation allows the user to see how the alerts are going to be grouped together under the rule before activating it.

FIG. 11 illustrates an example of an automation simulation report. The report includes a video simulation 1102 of the combined effects of multiple automation rules. Using historical alert data, a dynamic “What if?” analysis may be provided via an auto-generated video and interactive GUI. The user may observe the combined effects of tens to hundreds of rules. For example, different rules may be created to group alerts based on different metrics, and different rules may be created to incorporate different playbooks for different scenarios. Recommendations of these rules are provided, and instead of considering each rule individually, their combined effect is simulated using historical alert data.

A simulation is conducted to replicate past alerts and demonstrate the impact of the recommended rules. For instance, alerts generated 24 hours ago may be replicated, and by applying the suggested rules, the potential outcomes are demonstrated. A video is auto-generated to display the product UI and its records. In one example, the video illustrates the transformation of the alerts: the appearance of the playbook and the grouping of the alerts, which were previously treated independently. This approach provides users with a dynamic “What if?” analysis, visually representing how their data might have changed had the recommended rules been applied. Additionally, a transcript for the video may be generated, detailing the execution of each rule. This narrative, produced by a language model, describes the sequence of events, such as the application of the grouping rule followed by the playbook attachment. The presentation may further include text-to-speech narration alongside the product UI, which displays the various rules. Users can interact with this simulation, tweaking rules and observing the resultant changes. For example, after turning off two rules and re-running the simulation, users can assess the final state of their data and the modified UI, gaining insights into the effectiveness of their adjustments.

With reference to the examples in FIGS. 7-11, the LLM may have a context window, which is a predetermined threshold size of the context text/data that the LLM may receive in addition to the prompt for the RAG approach. Therefore, if the context data collected from the past three months is over the predetermined threshold input data size, a filter may be applied to input only a portion of the collected data that is below the threshold. In some embodiments, the inputs may be stored in the JavaScript Object Notation (JSON) format. JSON is a lightweight format for storing and transporting data. For example, alerts may be sent to the LLM in a simple JSON representation, with each alert containing a short description, a metric name, a node, a resource, or other fields.

An LLM prompt may include specific instructions, such as the instruction to assume the role of an operation lead, identify trends, make recommendations for grouping or remediation automation, and the like. The LLM prompt is constructed differently for different types of automatically generated recommended rules, including alert rules for grouping information, escalation/notification/remediation, and alert enrichment. For example, the LLM prompt for a remediation rule may be a natural language prompt “Given the alert and the technical support chat transcripts associated with it, the historical alerts in the last 3 months similar to this alert, and the resolution steps previously taken, generate a playbook.” For example, the LLM prompt for a grouping rule may be a natural language prompt “Given the historical alerts in the last 3 months related to the configuration item (CI) in question, generate an alert grouping rule.” For example, the LLM prompt for an alert enrichment may be a natural language prompt “Given the reassignment of the alert to another department based on the technical support chat transcripts, the historical alerts in the last 3 months similar to this alert, and the resolution steps previously taken, generate an alert enrichment rule.”

In some situations, changing the order of the automation rules may alter the outcomes of the groupings of the alerts or other actions. The user may specify via the GUI an ordering of the rules to be applied to the alerts or other objects, and review the simulated results to ensure that the intended objectives are met.

As shown in the examples in FIGS. 7-11, there are different types of automatically generated recommended rules, including alert rules for grouping information, escalation/notification/remediation, and alert enrichment. FIG. 9 and FIG. 10 show examples of grouping automation rules. In FIG. 8, GUI element 802 shows that the remediation actions generated for the group of alerts “Elevated error rate in Checkout” include running the playbook “Troubleshooting Error Rate in Checkout.”

FIGS. 12A, 12B, 12C, and 12D show additional examples of automatically generated rules for escalation/notification/remediation. FIG. 12A shows a list of rules for escalating alerts to incidents and notifying the IT team. FIG. 12B shows a GUI 1202 for defining the rule named “Uptime—to incident.” GUI 1202 allows the user to modify the trigger conditions of the rule. In particular, the user may modify the filter criteria that identify the alerts that should be captured. The automation is executed only when the alerts meet the configured conditions. FIG. 12C shows a GUI 1204 for defining the actions associated with the rule named “Uptime—to incident.” GUI 1204 allows the user to modify the automation actions triggered by the filtered alerts. In this example, an incident is created for alerts that match the conditions for this rule. FIG. 12D shows a GUI 1206 for selecting different actions associated with a rule, including creating an incident, sending an e-mail, using outbound webhooks to send data to other systems, running predefined remediations, and opening a web-based application.

Although the foregoing embodiments have been described in some detail for purposes of clarity of understanding, the disclosure is not limited to the details provided. There are many alternative ways of implementing the disclosure. The disclosed embodiments are illustrative and not restrictive.

What is claimed is:

1. A method comprising:
receiving information technology (IT) alert data comprising a plurality of IT alerts;
identifying, from a subset of the IT alert data, context information relevant to IT alert processing;
extracting, from the subset of the IT alert data, one or more patterns indicative of IT alert processing in response to the subset of the IT alert data;
determining, based on the one or more patterns and the context information, an IT alert processing rule; and
enabling, in a production environment, the IT alert processing rule.

2. The method of claim 1, further comprising:
generating, based on the one or more patterns and the context information, a query.

3. The method of claim 2, further comprising:
processing, using a machine learning (ML) model, the query to determine the IT alert processing rule.

4. The method of claim 3, further comprising:
generating the query by generating a large language model (LLM) prompt for an LLM to determine the IT alert processing rule, wherein the LLM prompt instructs the LLM to determine the IT alert processing rule based at least in part on the one or more patterns and the context information.

5. The method of claim 4, wherein the generating of the LLM prompt for the LLM to determine the IT alert processing rule comprises:
generating the LLM prompt for the LLM to determine the IT alert processing rule for grouping at least some IT alerts into an IT alert group, wherein the LLM prompt instructs the LLM to determine the IT alert processing rule based at least in part on one or more patterns of grouping at least some of the plurality of IT alerts into the IT alert group.

6. The method of claim 4, wherein the generating of the LLM prompt for the LLM to determine the IT alert processing rule comprises:
generating the LLM prompt for the LLM to determine the IT alert processing rule for remediating at least some IT alerts, wherein the LLM prompt instructs the LLM to determine the IT alert processing rule based at least in part on one or more patterns of remediating at least some of the plurality of IT alerts.

7. The method of claim 6, wherein remediating the at least some IT alerts comprises assigning criticality levels to the at least some IT alerts.

8. The method of claim 6, wherein remediating the at least some IT alerts comprises assigning a playbook comprising a plurality of steps or approvals across an organization.

9. The method of claim 4, wherein the generating of the LLM prompt for the LLM to determine the IT alert processing rule comprises:
generating the LLM prompt for the LLM to determine the IT alert processing rule for enrichment of at least some IT alerts, wherein the LLM prompt instructs the LLM to determine the IT alert processing rule based at least in part on one or more patterns of enrichment of at least some of the plurality of IT alerts.

10. The method of claim 9, wherein the enrichment of the at least some IT alerts comprises assigning one of the at least some IT alerts to a responsible department.

11. The method of claim 1, further comprising:
identifying the context information based on a technical support transcript related to an IT alert.

12. The method of claim 1, further comprising:
identifying the context information based on system or network data.

13. The method of claim 1, wherein receiving the IT alert data comprises:
receiving IT events, IT logs, IT traces, or IT performance metrics.

14. The method of claim 1, further comprising:
providing the IT alert processing rule to a user via a graphical user interface (GUI);
receiving one or more modifications to the IT alert processing rule from the GUI; and
enabling the IT alert processing rule with the one or more modifications.

15. The method of claim 1, further comprising:
simulating the IT alert processing rule using at least some of the IT alert data;
receiving, via a graphical user interface (GUI), an approval of the IT alert processing rule; and
enabling the IT alert processing rule in response to the approval.

16. A system comprising:
a processor configured to:
receive information technology (IT) alert data comprising a plurality of IT alerts;
identify, from a subset of the IT alert data, context information relevant to IT alert processing;
extract, from the subset of the IT alert data, one or more patterns indicative of IT alert processing in response to the subset of the IT alert data;
determine, based on the one or more patterns and the context information, an IT alert processing rule; and
enable, in a production environment, the IT alert processing rule; and
a memory coupled to the processor and configured to provide the processor with instructions.

17. The system of claim 16, wherein the processor is further configured to:
generate a large language model (LLM) prompt for an LLM to determine the IT alert processing rule, wherein the LLM prompt instructs the LLM to determine the IT alert processing rule based at least in part on the one or more patterns and the context information.

18. The system of claim 17, wherein the processor is further configured to:
generate the LLM prompt for the LLM to determine the IT alert processing rule for grouping at least some IT alerts into an IT alert group, wherein the LLM prompt instructs the LLM to determine the IT alert processing rule based at least in part on one or more patterns of grouping at least some of the plurality of IT alerts into the IT alert group.

19. The system of claim 17, wherein the processor is further configured to:
generate the LLM prompt for the LLM to determine the IT alert processing rule for remediating at least some IT alerts, wherein the LLM prompt instructs the LLM to determine the IT alert processing rule based at least in part on one or more patterns of remediating at least some of the plurality of IT alerts.

20. A computer program product embodied in a non-transitory computer readable medium and comprising computer instructions for:
receiving information technology (IT) alert data comprising a plurality of IT alerts;
identifying, from a subset of the IT alert data, context information relevant to IT alert processing;
extracting, from the subset of the IT alert data, one or more patterns indicative of IT alert processing in response to the subset of the IT alert data;
determining, based on the one or more patterns and the context information, an IT alert processing rule; and
enabling, in a production environment, the IT alert processing rule.
